(19) United States
(12) Patent Application Publication
(10) Pub. No.: US 2008/0274230 A1
(43) Pub. Date: Nov. 6, 2008

(54) Iron-Containing Human Milk Fortifier With Improved Antimicrobial Properties

(76) Inventors: Paul W. Johns, Columbus, OH (US); Bridget M. Barrett-Reis, Dublin, OH (US); Terry B. Mazer, New Albany, OH (US)

Correspondence Address: SHU-KI YEUNG, 936 WHITE STREET, SAINT LAURENT, QC, H4M2W6, CA

(21) Appl. No.: 10/575,292

(22) PCT Filed: Oct. 26, 2004
(86) PCT No.: PCT/US04/35505

§ 371 Date: Apr. 12, 2006

(30) Foreign Application Priority Data
Oct. 14, 2003 (IE) 2003/0760

(51) Int. Cl. A23C 9/20; A23L 1/305

(52) U.S. Cl. 426/2; 426/648

(57) ABSTRACT

Disclosed are human milk fortifier compositions, in either powder or liquid forms, comprising nutrients and selected iron-containing materials, wherein the fortifiers when added to human milk do not significantly inhibit or otherwise eliminate the inherent, in-vitro antimicrobial properties of the milk. This is accomplished by formulating the compositions with iron-containing insoluble iron, soluble bound iron, or combinations thereof, with little or no soluble unbound iron. Also disclosed are methods of providing nutrition to infants, especially preterm infants, by adding the human milk fortifier described herein with human milk to form a fortified human milk, and then administering the fortified human milk to the infant. The fortifier can also be used to fortify other infant formulas.

### TECHNICAL FIELD

The present invention relates to iron-containing human milk fortifier compositions with improved antimicrobial properties. The composition can be added to human milk without significantly reducing or otherwise eliminating the inherent in-vitro antimicrobial activity of human milk.

### BACKGROUND OF THE INVENTION

Human milk is generally recognized as an ideal feeding for most infants due to its overall nutritional composition. It is well known and generally accepted that human milk provides infants with unique immunologic and developmental benefits unequaled by commercial infant formulas.

For some infants, however, especially preterm infants, human milk does not always meet their complete nutritional needs. Although these infants still benefit from human milk, it is often desirable to supplement their human milk feedings with additional nutrients. Initially, these preterm infants grow more rapidly than many of their term counterparts, so that their accelerated growth often requires additional nutrition made possible by the use of a human milk fortifier in combination with human milk.

Human milk fortifiers are commercially available as unit dose powders that can be added to human milk prior to feeding. Examples of such fortifiers include Similac® Human Milk Fortifier®, available from Ross Products Division, Abbott Laboratories, Columbus, Ohio, and Enfamil® Human Milk Fortifier Powder, available from Mead Johnson, Evansville, Ind. Both products are unit dose powders that are added to about 25 ml of human milk prior to feeding, and both are most typically used in combination with human milk for preterm infants in neonatal intensive care units.

It is well known that human milk provides infants with immunological benefits, including supplementation with certain cellular and hormonal factors that protect infants against a variety of pathogens. It was recently reported, however, that certain fortifiers when added to human mills actually inhibit at least some of the natural antibacterial properties of human milk (see Chan G M, Powdered fortifier effects on preterm human milk's antibacterial action, Pediatric Research, 53 (2003)-421A). It was also reported that only those human milk fortifiers that contain higher iron concentrations inhibited the in-vitro antibacterial activity of human milk, whereas the fortifiers that were lower in iron content such as Similac® Human Milk Fortifier did not. The study looked specifically at the in vitro activity of fortified human milk against pathogens such as Escherichia coli, staphylococcus, group B streptococcus, and Enterobacter sakazakii. The report went on to speculate that the higher iron concentrations in the iron-fortified products (e.g., Enfamil® Human Milk Fortifier) were decreasing the antibacterial properties of human milk lactoferrin. A recent recommendation based on this earlier report now suggests that iron supplements, alone or in combination with human milk fortifier, not be added to human milk to thus maintain or otherwise not significantly negate the in vitro antimicrobial activity of the human milk.

It is therefore an object of the present invention to provide an iron-containing human milk fortifier that does not significantly negate or otherwise eliminate the inherent antimicrobial activity of human milk when the two are mixed together, especially when the fortifier contains relatively high iron concentrations. It is a further object of the present invention to provide such a composition, wherein the iron from the composition is highly bioavailable. It is a further object of the present invention to provide a human milk fortifier with iron for use in combination with human milk to provide infants, especially premature infants, with the additional or necessary nutrients to support optimal growth. These and other objects of the present invention are described hereinafter in greater detail.

### SUMMARY OF THE INVENTION

The present invention relates to human milk fortifier compositions comprising protein, lipid, carbohydrate, or combinations thereof, and selected iron-containing materials, wherein the fortifiers when added to human milk do not significantly inhibit or otherwise eliminate the antibacterial properties thereof.

The present invention includes a human milk fortifier composition comprising protein, lipid, carbohydrate, or combinations thereof; and an iron-containing material containing soluble unbound iron, insoluble iron, or combinations thereof; and from about 3 mg to about 30 mg soluble iron per 100 g of human milk fortifier solids in the composition. In this context iron solubility is measured or otherwise determined in accordance with the iron solubility method described herein.

The present invention also includes a human milk fortifier composition comprising protein, lipid, carbohydrate, or combinations thereof; and an iron-containing material comprising one or more of ferrous fumarate, ferrous succinate, ferric saccharate, ferric glycerophosphate, ferrous citrate, ferrous tartrate, ferric pyrophosphate, or ferric orthophosphate. These selected iron-containing materials provide for a larger fraction of insoluble iron, soluble bound iron, or combinations thereof.

The present invention also includes a human milk fortifier composition comprising protein, lipid, carbohydrate, or combinations thereof; from about 15 mg to about 110 mg of iron per 100 g of human milk fortifier solids; and an iron availability agent to increase the iron fraction that is in the form of insoluble iron, bound soluble iron, or combinations thereof, and thus reduce the iron fraction in the form of soluble unbound iron.

The present invention also includes a human milk fortifier composition comprising protein, lipid, carbohydrate, or combinations thereof; an iron-containing material; and at least about 0.1 g lactoferrin per mg of iron in the composition. The added lactoferrin provides for a larger fraction of insoluble iron, soluble bound iron, or combinations thereof, in fortified human milk.

The present invention also includes a human milk fortifier composition comprising protein, lipid, carbohydrate, or combinations thereof; and from about 15 mg to about 110 mg of iron per 100 g of fortifier solids, wherein from about 30% to 100% by weight of the iron in the composition is insoluble iron, soluble bound iron, or combinations thereof.

The present invention also includes a human milk fortifier composition comprising protein, lipid, carbohydrate, or combinations thereof; and an iron-containing material wherein from about 30% to about 70% by weight of the iron in the composition is insoluble iron, soluble bound iron, or combinations thereof.

The present invention also includes a human milk fortifier composition comprising protein, lipid, carbohydrate, or combinations thereof; and an iron-containing material wherein from about 10% to 100% by weight of the iron is insoluble iron, soluble bound iron, or combinations thereof, and wherein the composition is substantially free of ferrous sulfate, ferric sulfate, or combinations thereof.

It has been found that human milk fortifier compositions can be formulated with iron-containing materials, even when such materials provide the compositions with relatively high iron concentrations, without also reducing or eliminating the inherent antimicrobial activity of human milk, provided that the human milk fortifier is formulated with selected iron-containing materials, wherein the materials are formulated or otherwise selected so as to reduce, minimize or otherwise eliminate any soluble unbound iron concentrations in fortified human milk.

It has been found that the human milk fortifiers of the present invention can be formulated with iron-containing nutrients, including those that provide relatively high iron concentrations, without significantly reducing or otherwise eliminating the inherent, in-vitro, antimicrobial properties of human milk when the two are combined. It was previously believed that such antimicrobial properties of human milk could only be maintained if the human milk fortifier did not contain iron, or if it did, that iron concentrations should be kept to a minimum. It has now been found, however, that iron-containing materials or nutrients, even including those that provide relatively high iron concentrations, can be formulated into a human milk fortifier without the negative impact on human milk antimicrobial properties, provided that the iron-containing material is selected so as to reduce, minimize or otherwise eliminate any soluble unbound iron concentrations in the formulation.

It was also found that the human milk fortifiers with reduced soluble unbound iron concentrations can be realized by 1) merely selecting formulations that contain little or no solubilized unbound iron, wherein the unbound iron solubility is measured or otherwise determined in accordance with the unbound iron solubility method described herein, or 2) formulating the human milk fortifier composition with one or more iron-containing materials selected from the group consisting of ferrous fumarate, ferrous succinate, ferric saccharate, ferric glycerophosphate, ferrous citrate, ferrous tartrate, ferric pyrophosphate, and ferric orthophosphate, or 3) formulating the embodiments to further comprise an iron-containing material in combination with an iron availability agent as defined herein.

It was also found that the human milk fortifiers with reduced concentrations of soluble unbound iron can also be realized by 1) formulating the human milk fortifier with an iron-containing material in combination with at least about 0.1 g of lactoferrin per mg of iron in the human milk fortifier composition, or 2) formulating the human milk fortifier compositions with an iron-containing material having from about 30% to about 70% by weight of the iron in the composition as insoluble iron, soluble bound iron, or combinations thereof, or 3) formulating the human milk fortifier compositions with an iron-containing material, wherein from about 10% to 100% by weight of the resulting iron in the composition is insoluble iron, soluble bound iron, or combinations thereof, and wherein the composition is either substantially free of ferrous sulfate, ferric sulfate, or combinations thereof, or the total iron content exceeds about 15 mg per 100 g of fortifier solids, or 4) formulating the human milk fortifier compositions with an iron-containing material, wherein from about 10% to 100% by weight of the resulting iron in the composition is insoluble iron, soluble bound iron, or combinations thereof, and wherein the composition is substantially free of ferrous sulfate, ferric sulfate, or combinations thereof.

### DETAILED DESCRIPTION OF THE INVENTION

The human milk fortifier compositions of the present invention comprise as essential elements nutrients such as fat, lipid, carbohydrate, or combinations thereof, and iron-containing materials or compounds selectively defined herein, and other essential or optional characteristics of the human milk fortifiers of the present invention as described in greater detail hereinafter.

The term “soluble unbound iron” as used herein, unless otherwise specified, refers to those iron-containing materials that satisfy the analytical criteria as set forth in the unbound iron solubility method described herein.

The term “soluble bound iron” as used herein, unless otherwise specified, refers to all soluble iron other than the soluble unbound iron as defined herein.

The term “insoluble iron” as used herein, unless otherwise specified, refers to all iron-containing materials other than the soluble bound and unbound iron, all as defined herein.

The term “total iron” as used herein, unless otherwise specified, refers to the total iron concentration in the human milk fortifier composition of the present invention, which can be measured by conventional techniques well known in the relevant analytical chemistry arts.

All iron concentrations, amounts, and solubilities, including those that describe the terms “soluble unbound iron” and “soluble bound iron” and “soluble iron” and “insoluble iron” as referenced and defined herein, are characterized in terms of elemental iron, unless otherwise specified.

The term “infant” as used herein, refers generally to individuals less than about 1 year of age, actual or corrected.

The term “preterm” are used herein refers to those infants born at less than 37 weeks gestation, have a birth weight of less than 2500 gm, or both.

The terms “fortifier solids” or “total solids”, unless otherwise specified, are used interchangeably herein and refer to all material components of the compositions of the present invention, less water. For powder embodiments of the present invention, fortifier solids are generally equivalent to the powder weight, less 1-3% moisture associated with the powder. For liquid embodiments of the present invention, fortifier solids are equivalent to the total liquid composition weight, less water.

The term “lipid” as used herein, unless otherwise specified, means fats, oils, or combinations thereof.

The term “human milk fortifier” as used herein, unless otherwise specified, refers to nutritional compositions for use in combination and admixture with human milk or an infant nutritional formula, preferably human milk. Unless otherwise specified, the term “human milk fortifier” specifically excludes conventional infant formulas that provide the sole or primary source of infant nutrition and are not typically combined and admixed with human milk to supplement human milk feedings.

All percentages, parts and ratios as used herein are by weight of the total composition, unless otherwise specified. All such weights as they pertain to listed ingredients are based on the active level and, therefore, do not include solvents or by-products that may be included in commercially available materials, unless otherwise specified.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All numerical ranges as used herein, unless otherwise specified, are intended to be preceded by the term “about.”

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The compositions and methods of the present invention, including the many embodiments described herein, can comprise, consist of, or consist essentially of the essential elements and limitations of the invention described herein, as well as any additional or optional ingredients, components, or limitations described herein or otherwise useful in infant nutrition applications.

### I. Iron

The human milk fortifier of the present invention comprises an iron-containing component in combination with nutrients such as protein, carbohydrate, lipid, or combinations thereof. The iron-containing component is selected or otherwise formulated into the composition so as not to significantly reduce or otherwise eliminate the inherent, in-vitro antimicrobial activity of human milk when the two are combined prior to feeding.

The in-vitro antimicrobial activity of human milk, and the extent to which such activity is affected by the addition of a human milk fortifier, can be determined by conventional bacterial growth methods. For example, filter paper disks can be saturated with the sample liquid, e.g. human milk or fortified human milk and placed on blood agar plates inoculated with E. coli, staphylococcus, or group B streptococcus, for 36 hours. The diameter of the zone of inhibition is measured and compared to that resulting from a filter paper disk treated with human milk.

Iron-containing materials for use in the compositions of the present invention include any iron-containing material known or otherwise safe and effective for use in humans, especially infants, both term and preterm, provided that the iron-containing material has the requisite solubility or character profile as described herein, or can otherwise be formulated into the composition with such requisite characteristics. In general, the iron-containing materials most suitable for use herein are those that are insoluble or poorly soluble in human milk, or which can be formulated so as to minimize the soluble unbound iron content by other ingredients in the human milk fortifier composition. In this context, iron solubility and soluble unbound iron content are defined by and determined in accordance with the methods described hereinafter.

The human milk fortifier compositions include those embodiments comprising total iron concentrations ranging from about 10 mg to about 110 mg per 100 g of fortifier solids, from about 15 mg to about 95 mg per 100 g of fortifier solids, from about 20 mg to about 75 mg per 100 g of fortifier solids, or from about 30 mg to about 50 mg per 100 g of fortifier solids. In this context, total iron is calculated on an elemental iron basis.

The human milk fortifier compositions include those embodiments comprising insoluble iron, soluble bound iron, or combinations thereof, wherein these iron fractions collectively represent from about 10% to 100%, also including from about 30% to about 95%, also including from about 40% to about 95%, also including from about 50% to about 90%, also including from about 35% to about 65%, and also including from about 40% to about 60%, by weight of the total iron in the composition. For those embodiments comprising from about 30% to 100%, preferably from about 40% to 95%, insoluble iron, soluble bound iron, or both, such compositions contain at least about 25 mg, more preferably from about 30 mg to about 110 mg, of iron per 100 g of fortifier solids.

The human milk fortifier compositions of the present invention include those embodiments, wherein the iron-containing material in the composition provides a reduced concentration of solubilized iron, wherein the embodied compositions comprise from about 3 mg to about 30 mg, from about 3 mg to about 28 mg, from about 5 mg to about 25 mg, or from about 10 mg to about 20 mg, of solubilized iron per 100 g of human milk fortifier solids.

It has been found that soluble unbound iron is largely responsible for the negative impact on human milk antimicrobial properties, not the total iron content as was previously reported in the literature. Although there is also a strong correlation between soluble iron concentrations and inhibition of human milk antimicrobial activity, it has also been found that here is an even stronger correlation when the soluble iron fraction of the composition is further characterized in terms of soluble unbound iron. It has therefore been found that soluble unbound iron reduces human milk antimicrobial activity, whereas insoluble iron and soluble bound iron does not, or if it does then to a much lesser extent. A human milk fortifier can therefore now be formulated with various iron concentrations, even relatively high iron concentrations, provided that the iron-containing material comprises soluble bound iron, insoluble iron, or both, with minimal or no soluble unbound iron.

### Select Iron-Containing Materials

The human milk fortifier compositions of the present invention also include those embodiments, wherein the iron-containing material comprises one or more of ferrous fumarate, ferrous succinate, ferric saccharate, ferric glycerophosphate, ferrous citrate, ferrous tartrate, ferric pyrophosphate, and ferric orthophosphate, preferably one or more of ferrous fumarate, ferrous succinate, ferric saccharate, ferric glycerophosphate, ferrous citrate, and ferrous tartrate.

Other suitable iron-containing materials include iron-bound nutrients such as iron bound proteins, amino acids, or carbohydrates, many examples of which are known in the various nutrition related arts, e.g., ferrous glycinate.

### Iron Availability Agent

The human milk fortifier compositions of the present invention also include those embodiments, wherein the availability profile of the iron-containing material is modified by other ingredients or conditions referred to herein as “iron availability agents”, which agents are defined herein as materials or conditions that can reduce or minimize unbound soluble iron concentrations, preferably by either increasing 1) the insoluble iron fraction, 2) the soluble unbound iron fraction, or 3) both. These iron availability agents include any material or combination of materials that minimize soluble unbound iron content in favor of iron forms such as soluble bound iron, insoluble iron, or both, which are not as readily available in human milk to negatively impact in vitro human milk antimicrobial characteristics.

Non-limiting examples of iron availability agents include iron binding agents or any other ingredient or formula functionality that renders at least a fraction of the total iron component insoluble (or soluble but bound) in fortified human milk. It should be noted, however, that iron availability in this context refers to availability of the iron for hampering in vitro antimicrobial human milk characteristics, not nutritional bioavailability of the iron following oral administration to an infant.

Non-limiting examples of iron availability agents for use in the human milk fortifier compositions of the present invention include salts such as NaH₂PO₄; Na₂HPO₄; KH₂PO₄; K₂HPO₄; H₃PO₄; calcium salts such as Ca glycerophosphate, Ca(H₂PO₄)₂, CaHPO₄, Ca₃(PO₄)₂, Ca₂P₂O₇; magnesium salts such as Mg(H₂PO₄)₂, MgHPO₄, Mg₃(PO₄)₂, Mg₂P₂O₇); and combinations thereof. The concentration or amount of the iron availability agent is preferably high enough so as to reduce the total soluble unbound iron concentration in fortified human milk, as compared to human milk fortified with a comparable formula without the added iron availability agent. In this context, lowering of the soluble unbound iron fraction preferably results in a lowering of soluble iron, preferably soluble unbound iron, by at least about 10%, more preferably by at least about 50%, more preferably from about 70% to about 100%, by weight of the corresponding soluble iron or soluble unbound iron content in human milk fortified with a comparable formula without the iron availability agent.

The following table shows the effect of a representative iron availability agent, NaH₂PO₄, on the soluble iron content of Similac® Human Milk Fortifier, a commercially available human milk fortifier powder.

TABLE 1
Iron Availability agent

| | Similac ® | | | | | | Soluble |
|---|---|---|---|---|---|---|---|
| | Human | | Fe (μg) | | PO₄ (mg) | | Fe |
| | Milk | Water | added as | | added as | | μg |
| | Fortifier ¹ (mg) | (ml) | FeSO₄ | | NaH₂PO₄ | | (n = 3) |
| A | 927 | 25 ml | 0 | μg | 0 | mg | 16 ± 4 |
| B | 932 | 25 ml | 360 | μg | 0 | mg | 192 ± 6 |
| C | 937 | 25 ml | 360 | μg | 6.14 | mg | 196 ± 8 |
| D | 930 | 25 ml | 360 | μg | 12.3 | mg | 186 ± 11 |
| E | 977 | 25 ml | 360 | μg | 18.4 | mg | 178 ± 7 |
| F | 946 | 25 ml | 360 | μg | 24.6 | mg | 170 ± 6 |
| G | 958 | 25 ml | 360 | μg | 30.7 | mg | 157 ± 10 |
| H | 925 | 25 ml | 360 | μg | 36.8 | mg | 141 ± 9 |

¹ Ross Products Division, Abbott Laboratories, Columbus, Ohio U.S.A.

### Lactoferrin

The human milk fortifier compositions of the present invention also include those embodiments comprising at least about 0.1 g of lactoferrin per mg of iron in the composition. Other embodiments include at least about 0.5 g of lactoferrin per mg of iron, or from about 0.7 g to about 3 g, of lactoferrin per mg of iron in the composition.

It has been found that lactoferrin can be helpful in reducing soluble unbound iron fractions, and thus in further reducing or otherwise avoiding the negative impact of the fortifier composition on the inherent in vitro antimicrobial activity of human milk when the two are combined prior to feeding, provided that the amount of lactoferrin relative to the iron content of the composition falls within the above recited ranges.

Lactoferrin sources suitable for use in the compositions of the present invention include any known or otherwise suitable human or non-human source of lactoferrin for use in feeding preterm or term infants, non-limiting examples of which include human, bovine, genetically modified plants, or combinations thereof. Human and bovine lactoferrin sources are preferred at this time.

Although lactoferrin is well known for use in infant formulas for a variety of purposes, some examples of which are described in U.S. Pat. No. 4,977,137 (Nichols et al.), its use in a human milk fortifier to reduce soluble unbound iron content and help maintain the in vitro antimicrobial properties of human milk has not previously been reported.

### Substantially Free of Iron Sulfate

For those embodiments of the present invention that are also substantially free of ferrous sulfate, ferric sulfate, or combinations thereof, the iron-containing material may comprise from about 10% to 100%, including from about 50% to about 95%, of insoluble iron, soluble bound iron, or both, by weight of the total iron in the composition. In this context, the term “substantially free” means that this particular embodiment contains less than 8 mg of ferrous or ferric sulfate, including less than 1 mg of ferrous or ferric sulfate, and also including zero mg of ferrous or ferric sulfate, as elemental iron per 100 g of fortifier solids.

### Other Iron-Containing Materials

The iron-containing component of the compositions of the present invention can include any known or otherwise suitable iron-containing material for use in infant nutritional products, provided that the iron-containing component as formulated into the human milk fortifier does not significantly reduce or otherwise eliminate the inherent, in vitro antimicrobial activity of human milk once the two are combined.

It has been found that these iron-containing components are most effective in maintaining in vitro antimicrobial activity of human milk when selected from the group consisting of ferrous fumarate, ferrous succinate, ferric saccharate, ferric glycerophosphate, ferrous citrate, ferrous tartrate, ferric pyrophosphate, ferric orthophosphate, and combinations thereof.

As noted above, the human milk fortifier compositions may comprise any iron-containing material from the many iron salts, complexes or compounds available regardless of their inherent water solubility as measured by conventional solubility methods other than the iron solubility methods described herein, provided that the solubility of the salt does not exceed the above recited range, or provided that the salt is formulated so as to otherwise have a reduced soluble unbound fraction, for example in combination with an iron availability agent as defined hereinbefore.

Although less preferred, non-limiting examples of conventional water-soluble iron-containing materials suitable for use herein include ferrous sulfate, ferrous gluconate, ferrous lactate, ferric ammonium citrate, ferrous ammonium sulfate, ferric choline citrate, and combinations thereof. The compositions are preferably substantially free (as defined herein) of ferrous sulfate, a commonly used iron-containing material found in many infant formulas.

### Dietary Iron Recommendation

The human milk fortifier of the present invention comprises iron-containing components as described hereinbefore, concentrations of which are generally and preferably guided by the recommended iron supplements for the targeted infant population, which may include preterm infants.

The human milk fortifier of the present invention preferably provides sufficient dietary iron to meet the dietary or specific medical needs of the individual infant, when used alone or in combination with human milk, infant formula, or other nutrient source. In most cases, it is generally accepted that such infants receive at least 1 mg of iron per kg of body weight per day from all sources. Variations in daily recommended iron intake can be affected by a number of variables such as the weight and maturity of the infant at birth, the particular medical condition or needs of the infant, especially as such conditions or needs apply to the preterm infant, as well as the bioavailability of the iron from the selected source of nutrition.

It has been found that the human milk fortifier of the present invention can be formulated with iron-containing materials without significantly reducing or eliminating the natural in vitro antimicrobial properties of human milk, thus obviating the need to necessarily provide the infant with iron supplements separate from their feedings, or at least reducing the extent to which such iron supplements are needed in addition to daily infant feedings.

### II. Product Form

The human milk fortifier of the present invention includes any product form suitable for combination with human milk, including powders or other dispersible or dissolvable particulates, liquids or liquid concentrates, dissolvable or dispersible tablets or pellets, and multi-compartment product forms, e.g., fortifier ingredients separated in two or more associated compartments prior to mixing with human milk. Powders are preferred.

The present invention includes those embodiments that comprise human milk fortifier packaged in unit dose packages or containers. These unit dose packages are single use containers that alone, or in combination with other unit dose packages, provide sufficient human milk fortifier to supplement human milk for immediate use, e.g., preferably within 8-24 hours, more preferably within 0-3 hours, of mixing with human milk.

The present invention includes human milk fortifier compositions in powder form, which is preferably packaged in the above-described unit dose packages. The amount of powder in each unit does package is preferably the amount needed to prepare an infants' next feeding. These unit dose packages typically contain from about 0.5 g to about 10 g, more typically from about 0.8 g to about 5.0 g, more typically from about 0.85 g to about 2.0 g, of the human milk fortifier powder. The human milk fortifier powder embodiments include those having a caloric density of from about 1.0 kcal/g powder to about 8.5 kcal/g powder.

The present invention also includes human milk fortifier in liquid or concentrated liquid forms. As with the powder embodiment of the present invention, the liquid form is likewise preferably manufactured into unit dose packages. As with the powder embodiments of the present invention, suitable unit dose packages include any known or otherwise suitable package for single use application of or in association with infant nutrition products. The term “liquid concentrate” as used herein, unless otherwise specified, refers to those liquid embodiments that are preferably combined with human milk in a volume/volume ratio of fortifier liquid to human milk of at least about 1:2, more preferably at least about 1:3, even more preferably from about 1:4 to about 1:10.

The human milk fortifier of the present invention is preferably formulated so as to provide fortified human milk having an osmolality of less than about 400 mOsm/kg water, preferably from about 300 mOsm/kg water to about 400 mOsm/kg water. One skilled in the art can readily formulate the human milk fortifier with the appropriate carbohydrate sources and corresponding DE (dextrose equivalence) values to obtain or otherwise provide for the targeted osmolality of the human milk fortifier when combined with human milk.

The term “unit dose” as used herein refers to individual, single-use, packages of human milk fortifier, including powder and liquid embodiments, containing an amount of human milk fortifier that can be used in a preparation of an infant feeding. The amount of fortified human milk prepared for a premature infant, for example, typically ranges from 25 ml to 150 ml a day. Consequently, a single unit dose is the appropriate amount of fortifier solids to fortify a 25 ml preparation. Multiple packages can be used to prepare larger feeding volumes, especially for term infants.

The human milk fortifier includes liquid embodiments that can be added directly to infant formula or human milk, preferably human milk, prior to feeding. The liquid embodiments have a total solids content of at least about 12%, including from about 12% to about 50%, also including from about 20% to about 40%, and also including from about 20% to about 30%, by weight of the liquid composition. The remainder of the composition is typically water, e.g., less than about 88%, including from about 50% to about 88%, also including from about 60% to about 80%, and also including from about 70% to about 80%, by weight of water. The liquid embodiments are preferably concentrated compositions containing at least about 20% fortifier solids by weight of the liquid composition, with the non-fortifier solids generally being added or ingredient associated water, i.e., less than about 80% by weight of water.

### III. Nutrients

In addition to the iron component described herein, the human milk fortifier of the present invention further comprises sufficient types and amounts of nutrients, that when used in combination with human milk, help meet the nutritional needs of the infant. These nutrients include lipids, proteins, carbohydrates, or combinations thereof, and preferably also include vitamins, minerals (in addition to the iron-containing material), or combinations thereof.

Many different sources and types of carbohydrates, lipids, proteins, minerals and vitamins are known and can be used in the compositions of the present invention, provided that such nutrients are compatible with the added ingredients in the selected formulations are safe and effective for their intended use, and do not otherwise unduly impair product performance.

The human milk fortifiers of the present invention include those embodiments comprising or otherwise providing for the carbohydrate, lipid, and protein concentrations as set forth in the following Table 2.

TABLE 2
Nutrient Concentrations

| | | g/100 kcal | g/100 g | |
|---|---|---|---|---|
| | | of | of | g/L of |
| | | fortifier | fortifier | human |
| Nutrient | Range | solids | solids | milk |
| Carbohydrate | 1^{st} embodiment | 8-16 | 15-75 | 54-108 |
| | 2^{nd} embodiment | 9-13 | 38-70 | 61-88 |
| | 3^{rd} embodiment | | 46-64 | |
| Lipid | 1^{st} embodiment | 3-8 | 1-30 | 20-54 |
| | 2^{nd} embodiment | 4-6.6 | 5-20 | 27-45 |
| | 3^{rd} embodiment | | 8-18 | |
| Protein | 1^{st} embodiment | 1-3.5 | 24-55 | 7-24 |
| | 2^{nd} embodiment | 1.5-3.4 | 25-42 | 10-23 |
| | 3^{rd} embodiment | | 28-36 | |

### Carbohydrate

Carbohydrates for use in the compositions of the present invention may include hydrolyzed or intact, naturally and/or chemically modified, starches sourced from corn, tapioca, rice or potato, in waxy or non-waxy forms. Other non-limiting examples of suitable carbohydrate sources include hydrolyzed cornstarch, maltodextrin (i.e. non-sweet, nutritive polysaccharide having a DE value less than 20), glucose polymers, sucrose, corn syrup, corn syrup solids (i.e., polysaccharide having a DE value greater than 20), glucose, rice syrup, fructose, high fructose corn syrup, indigestible oligosaccharides such as fructooligosaccharides (FOS), and combinations thereof. The carbohydrates can comprise lactose or can be substantially free of lactose.

### Protein

Proteins for use in the compositions of the present invention may include intact and hydrolyzed proteins, free amino acids, and combinations thereof. Non-limiting examples of suitable proteins include hydrolyzed, partially hydrolyzed or non-hydrolyzed protein, and can be derived from any known or otherwise suitable source such as milk (e.g., casein, whey, lactose-free milk protein isolates), animal (e.g., meat, fish), cereal (e.g., rice, corn), vegetable (e.g., soy), or combinations thereof. The protein can include, or be entirely or partially replaced by, free amino acids known or otherwise suitable for use in nutritional products, non-limiting examples of which include Non-limiting examples of free amino acids include L-alanine, L-arginine, L-asparagine, L-aspartic acid, L-carnitine, L-cystine, L-glutamic acid, L-glutamine, glycine, L-histidine, L-isoleucine, L-leucine, L-lysine, L-methionine, L-phenylalanine, L-proline, L-serine, L-taurine, L-threonine, L-tryptophan, L-tyrosine, L-valine, and combinations thereof.

### Lipids

Lipids suitable for use in the compositions of the present invention may include coconut oil, soy oil, corn oil, olive oil, safflower oil, high oleic safflower oil, MCT oil (medium chain triglycerides), sunflower oil, high oleic sunflower oil structured triglycerides, palm and palm kernel oils, palm olein, canola oil, marine oils, cottonseed oils, and combinations thereof.

Suitable lipids for use in the human milk fortifier includes emulsifiers to help the various fortifier components readily disperse when combined with human milk. Non-limiting examples of suitable emulsifiers include soya bean lecitin, polyoxyethylene stearate, polyoxyethylene sorbitan mono-oleate, polyoxyethylene sorbitan monopalmitate, polyoxyethylene sorbitan monostearate, ammonium phosphatides, polyoxyethylene sorbitan monolaurate, citric acid esters of mono and diglycerides of fatty acids, tartaric acid esters of mono and diglycerides of fatty acids, and combinations thereof. Natural soy lecithin is a preferred emulsifier for use herein.

The lipid component of the human milk fortifier may therefore include any emulsifier suitable for use in infant nutritional products. Emulsifier concentrations in these products preferably comprise up to about 10%, more typically from about 1% to about 10%, even more typically from about 1.5% to about 5%, of an emulsifier by weight of the lipid component. For powder embodiments of the present invention, the emulsifier concentration most typically ranges from about 0.1% to about 1.0% by weight of human milk fortifier powder. In the resulting combination of human milk and human milk fortifier, the amount of emulsifier typically ranges from about 0.36% to about 3.6%, more preferably from about 0.54% to about 1.8%, on a weight-volume basis with respect to the fortified human milk.

The human milk fortifier of the present invention also includes those embodiments that comprise as part of the lipid component one or more of arachidonic acid, docosahexaenoic acid, or combinations thereof, alone or in further combination with linoleic acid, linolenic acid, or both. These lipids and their use in promoting infant development, especially preterm infant development, are described in U.S. Pat. No. 6,495,599 (Auestad et al.), which description is incorporated herein by reference.

### Vitamins and Minerals

The human milk fortifier of the present invention may further comprise any of a variety of vitamins, non-limiting examples of which include vitamin A, vitamin D, vitamin E, vitamin K, thiamine, riboflavin, pyridoxine, vitamin B₁₂, niacin, folic acid, pantothenic acid, biotin, vitamin C, choline, inositol, salts and derivatives thereof, and combinations thereof.

In addition to the iron-containing material described herein, the human milk fortifier may further comprise any of a variety of minerals known or otherwise suitable for us in infant or other nutritional formulas, non-limiting examples of which include calcium, phosphorus, magnesium, zinc, manganese, copper, iodine, sodium, potassium, chloride, selenium, and combinations thereof.

The human milk fortifier of the present invention includes those embodiments comprising per 100 kcal of fortifier solids one or more of the following: vitamin A (from about 250 to about 750 IU), vitamin D (from about 40 to about 100 IU), vitamin K (greater than about 4 μm), vitamin E (at least about 0.3 IU), vitamin C (at least about 8 mg), thiamine (at least about 8 μg), vitamin B₁₂ (at least about 0.15 μg), niacin (at least about 250 μg), folic acid (at least about 4 μg), pantothenic acid (at least about 300 μg), biotin (at least about 1.5 μg), choline (at least about 7 mg), and inositol (at least about 2 mg).

The human milk fortifier of the present invention also includes those embodiments comprising per 100 kcal of the fortifier solids one or more of the following: calcium (at least about 50 mg), phosphorus (at least about 25 mg), magnesium (at least about 6 mg), iodine (at least about 5 μg), zinc (at least about 0.5 mg), copper (at least about 60 μg), manganese (at least about 5 μg), sodium (from about 20 to about 60 mg), potassium (from about 80 to about 200 mg), chloride (from about 55 to about 150 mg) and selenium (at least about 0.5 mcg).

The human milk fortifier preferably comprises calcium in the form of an insoluble calcium source. In this context, the term “insoluble” means that the calcium as formulated into the fortifier composition does not readily go into solution when combined with human milk, such that less than 50% (w/w) of the total calcium present in the fortifier, after mixing with human milk at room temperature in the prescribed proportions, will pass through a 0.45 um filter.

Non-limiting examples of suitable insoluble calcium sources include calcium phosphate dibasic, calcium phosphate tribasic and calcium carbonate, calcium citrate, and combinations thereof. Alternatively, the insoluble calcium source can be in the form of a colloidal suspension with the protein, e.g., calcium caseinate. Preferably, about 95% by weight of the total calcium in the human milk fortifier is supplied by calcium phosphate tribasic and about 5% of the total calcium is supplied by calcium citrate.

### IV. Other Optional Ingredients

The human milk fortifier of the present invention may further comprise other optional ingredients that may modify the physical, chemical, aesthetic or processing characteristics of the formulas or serve as pharmaceutical or additional nutritional components when used in the targeted population. Many such optional ingredients are known for use in food and nutritional products, including infant formulas, and may also be used in the nutritional compositions of the present invention, provided that such optional materials are compatible with the essential materials described herein, are safe and effective for their intended use, and do not otherwise unduly impair product performance.

Non-limiting examples of such optional ingredients include preservatives, anti-oxidants, various pharmaceuticals, buffers, colorants, flavors, nucleotides and nucleosides, thickening agents, stabilizers, prebiotics, probiotics, and other excipients or processing aids.

### V. Iron Solubility Method

The iron solubility method described herein defines the method by which soluble iron content of various human milk fortifier embodiments of the present invention is determined. The method is generally directed to the quantification of soluble iron from a product sample by measuring a calorimetric increase in visible absorbance after the addition of an iron-selective derivitization reagent such as ferrozine. The iron solubility method is distinct from the unbound iron solubility method, which is also described and defined herein.

The iron solubility method is particularly useful in characterizing certain embodiments of the present invention, wherein the soluble iron content of the sample product is defined by the iron-containing material and its solubility as formulated into the composition and combined with human milk, not in isolation and separate from the product sample. In other words, iron solubility as defined herein means solubility as formulated into a product sample and combined with human milk, not inherent solubility of an iron-containing material as determined by more conventional solubility or water-solubility methods. An iron-containing material such as ferrous sulfate, for example, which is generally described in the literature as water soluble, could be considered for purposes of the present invention as either soluble or insoluble iron, in whole or in part, depending upon its iron solubility in the finished product formula as determined by the iron solubility method herein.

The iron solubility method is described below:
1. To 25 mL of untreated human milk, add a quantity of human milk fortifier that is intended for 25 mL of human milk. If an iron salt is to be evaluated, then, in addition to the human milk fortifier, a quantity of the iron salt which contains 360 μg of iron [Fe(II) and/or Fe(III)] should also be added.
2. Stir vigorously for fifteen minutes at room temperature.
3. Centrifuge at 12100×g and at 10° C. for 120 minutes.
4. Pipet 1000 μL of supernatant into a 2 mL glass ampule (Wheaton #176776).
5. Pipet 1000 μL of hydrochloric acid (Aldrich #25, 814-8) into the ampule.
6. Flame-seal ampule, and place it in a 110° C. oven for 16 hours.
7. Cool to room temperature, and filter the acid digest through a 0.45 um GHP membrane (Gelman Acrodisc 25 mm syringe filter, PIN 4560T).
8. Pipet 125 μL of filtrate into a 1 dram vial.
9. Add 75 μL of 10N sodium hydroxide (Mallinckrodt H385).
10. Add 200 μL of Milli-Q water.
11. Add 2.00 mL of 0.10M sodium acetate (Mallinckrodt 7364), pH 4.5, containing hydroxylamine hydrochloride (Aldrich #25, 558-0) at 1.5% (w/v).
12. Add 50 μL of ferrozine solution, which is 0.10M sodium acetate, pH 4.5, containing 1.5% (w/v) hydroxylamine hydrochloride and 0.85% (w/v) ferrozine (Fluka #82950).
13. Between 2 minutes and 10 minutes after ferrozine solution addition, measure the sample solution absorbance at 560 nm.
14. A sample blank (steps 8-13, without ferrozine addition) must be included for each sample, and the sample blank absorbance must be subtracted from the sample absorbance.
15. A reagent blank (steps 4-13, using Milli-Q water instead of supernatant) must also be included, and the reagent blank absorbance must be subtracted from the sample absorbance.
16. The system is calibrated by two or more iron standard solutions (ferrous sulfate heptahydrate in Milli-Q water), prepared at 0-5.00 mg/L.
17. The soluble iron concentration in the sample solution is calculated by absorbance proportionation vs. the iron standard solution response (absorbance at 560 nm vs. mg/L of iron).

The iron solubility method described above is used to determine iron solubility and soluble iron content of a variety of nutritional materials once combined with human milk. Examples of some iron solubility method results are set forth in the following table.

TABLE 3
Iron Solability Values

| | | Soluble iron, |
|---|---|---|
| | Sample | mg/Liter |
| A | Human milk | <0.1 (n = 3) |
| B | Human milk 25 ml + 1 packet | 11.2 ± 0.5 (n = 3) |
| | (0.71 g) Enfamil ® HMF¹ | |
| C | Human milk 25 ml + 1 packet | 0.89 ± 0.03 (n = 3) |
| | (0.9 g) Similac ® HMF² | |
| D | Human milk + 14.4 mg/L | <0.1 |
| | ferric phosphate | |
| E | Human milk + 14.4 mg/L | 11.0 ± 0.4 |
| | ferrous sulfate | |

¹Mead Johnson Nutritionals, Evansville, Indiana, USA
²Ross Products Division, Abbott Laboratories, Columbus, Ohio, USA

The human milk fortifier compositions of the present invention also includes embodiments characterized by limitations on soluble unbound iron concentrations. These soluble unbound iron concentrations are determined in accordance with the soluble unbound iron solubility method defined below.
1. An appropriate feeding amount of human milk fortifier is added to 25 ml of human milk.
2. The fortified human milk is vigorously stirred for 15 minutes at room temperature.
3. The stirred combination is then centrifuged at 48,400×g and at 10° C. for 12 hours.
4. About 3.00 ml of the resulting supernatant is diluted to 50 ml with 0.05M sodium acetate buffer, pH 4.5, containing hydroxylamine hydrochloride at 1.5% (w/v).
5. The buffered suspension is filtered through a 0.45 μm membrane filter (Gelman Acrodisc 4560T).
6. To 2.40 ml of filtrated, 50 μL of ferrozine reagent is added, which is 0.85% (w/v) ferrozine in 0.05M sodium acetate buffer, pH 4.5, containing hydroxylamine hydrochloride at 1.5% (w/v).
7. After 2-10 minutes following ferrozine addition, a spectrophotometer is used to measure the filtrate absorbance at 560 nm (Note—the absorbance of a filtrate blank—filtrate without ferrozine addition—must also be measured, and the value subtracted from the filtrate+ferrozine value).
8. The filtrate iron concentration, i.e., soluble unbound iron, is calculated by linear regression from a standard curve of absorbance vs. iron concentration.

The soluble bound iron concentration can then be calculated as the difference between the soluble iron and soluble unbound iron concentrations as determined in accordance with the solubility methods described herein. The insoluble iron content is then calculated as the difference between the total iron and soluble iron concentrations.

### VI. Method of Manufacture

The human milk fortifier of the present invention may be prepared by any known or otherwise effective technique, suitable for making and formulating the selected infant nutritional product form. One such method as applied to human milk fortifiers in powder form is described in U.S. Pat. No. 6,294,206 (Barrett-Reis et al.), which description is incorporated herein by reference.

The human milk fortifier can be manufactured using techniques well known to those skilled in the nutritional formula art for preparing infant nutritional powders or liquids. While manufacturing variations are well known to those skilled in the nutritional formula art, a few of the manufacturing techniques are described hereinafter in greater detail (see Examples).

Generally speaking, however, the human milk fortifier composition can be prepared by forming an oil blend containing all oils, any emulsifier, and any fat-soluble vitamins. Two more slurries (carbohydrate and protein) are prepared separately by mixing the carbohydrate and any minerals together and then mixing the protein by itself with water to form an aqueous protein slurry, all of which is then mixed together with the oil blend. The resulting combination is then homogenized, heat processed, standardized with any water-soluble vitamins, and when a powder embodiment is desired, the resulting liquid is then dried, typically by spray drying. For powder embodiments of the present invention, the resulting powder may be milled to a specific particle size and/or agglomerated to modify particle size and mixability characteristics. Those skilled in the nutritional formula arts would also be able to dry blend the individual starting materials and add the liquid ingredients through agglomeration or during the dry blending step.

The human milk fortifier composition is preferably stored in unit dose packages as described hereinbefore, although it may be packaged into any container system known or otherwise suitable for use with infant nutritional products. Preferred are unit dose packages, many of which are suitable for use herein, non-limiting examples of which include packets or sachets which may be manufactured of paper, foil and plastic film, and foil and plastic film coated paper; and ampoules which may be manufactured of plastic, reinforced paper and glass.

### VII. Method of Use

The present invention includes a method of providing nutrition to infants, especially preterm infants, by combining the human milk fortifier as described herein with infant formula or human milk, preferably human milk, and then feeding the resulting fortified formula or human milk in an appropriate amount to the infant, especially the premature infant.

The compositions of the present invention can also be formulated or used as infant formulas for term or preterm infants, wherein the infant formulas are fed to infants as the sole, primary, or supplementary nutrition, preferably as primary or supplementary nutrition in combination with human milk. When formulated or used as an infant formula, the product nutrients are modified so as to meet the nutritional needs of the infant. Caloric density for infant formula embodiments, as formulated or as prepared prior to use (e.g., conventional dilution with water prior to use), generally range from about 19 kcal/fl oz. to about 24 kcal/fl oz., with the 22-24 kcal/fl oz formulations being more useful in preterm infants, and the 19-21 kcal/fl oz formulations more useful for term infants.

### VI. EXAMPLES

The following examples illustrate specific embodiments of the human milk fortifiers of the present invention, including methods of making the compositions, and methods of using the compositions to provide nutrition to infants. The examples are given solely for the purpose of illustration and are not to be construed as limitations of the present invention, as many variations thereof are possible without departing from the spirit and scope of the invention.

TABLE 4.0
Human Milk Fortifier Powder Formulas ¹

| Nutrients | Formula | Formula | Formula | Formula |
|---|---|---|---|---|
| Amount per 4 packets | I | II | III | IV |
| Energy, kcal | 14 | 14 | 14 | 14 |
| Protein, g | 1.0 | 1.1 | 1.0 | 1.1 |
| Lipid, g | 0.36 | 1.0 | 0.36 | 1.0 |
| Carbohydrate, g | 1.8 | 0.4 | 1.8 | 0.4 |
| Vitamins | | | | |
| Vitamin A, IU | 620 | 950 | 620 | 950 |
| Vitamin D, IU | 120 | 150 | 120 | 150 |
| Vitamin E, IU | 3.2 | 4.6 | 3.2 | 4.6 |
| Vitamin K, mcg | 8.3 | 4.4 | 8.3 | 4.4 |
| Thiamine, mcg | 233 | 150 | 233 | 150 |
| Riboflavin, mcg | 417 | 220 | 417 | 220 |
| Vitamin B6, mcg | 211 | 115 | 211 | 115 |
| Vitamin B12, mcg | 0.64 | 0.18 | 0.64 | 0.18 |
| Niacin, mg | 3.57 | 3.00 | 3.57 | 3.00 |
| Folic acid, mcg | 23 | 25 | 23 | 25 |
| Pantothenic acid, | 1.5 | 0.73 | 1.5 | 0.73 |
| mg | | | | |
| Biotin, mcg | 26 | 2.7 | 26 | 2.7 |
| Minerals | | | | |
| Calcium, mg | 117 | 90 | 117 | 90 |
| Phosphorus, mg | 67 | 50 | 67 | 110 ³ |
| Magnesium, mg | 7.0 | 1.0 | 7.0 | 1.0 |
| Iron ², mg | 0.35-1.44 | 0.35-1.44 | 0.35-1.44 | 0.35-1.44 |
| Zinc, mg | 1.0 | 0.72 | 1.0 | 0.72 |
| Manganese, mcg | 7.2 | 10 | 7.2 | 10 |
| Copper, mcg | 170 | 44 | 170 | 44 |
| Sodium, mg | 15 | 16 | 15 | 16 |
| Potassium, mg | 63 | 29 | 63 | 29 |
| Chloride, mg | 38 | 13 | 38 | 13 |
| Lactoferrin | | | [ ] ⁴ | |

¹ Powder formulation in unit dose packets, 0.79 g human milk fortifier solids per packet
² Iron containing materials and concentrations listed in Table 4.1
³ Phosphorous provided as KH₂PO₄
⁴ Lactoferrin 1 g per mg of total iron

TABLE 4.1
Human Milk Fortifier Powder Formulas - Working Examples¹

| Iron-containing | Formula I | | | | | Formula II | | | | |
|---|---|---|---|---|---|---|---|---|---|---|
| material | Ex. 1 | Ex 2 | Ex. 3 | Ex. 4 | Ex. 5 | Ex. 6 | Ex. 7 | Ex. 8 | Ex. 9 | Ex. 10 |
| Ferrous fumarate | 0.35 | 0.75 | 1.0 | 1.2 | 1.44 | 0.35 | 0.75 | 1.0 | 1.2 | 1.44 |
| Ferrous succinate | 0.35 | 0.75 | 1.0 | 1.2 | 1.44 | 0.35 | 0.75 | 1.0 | 1.2 | 1.44 |
| Ferric saccharate | 0.35 | 0.75 | 1.0 | 1.2 | 1.44 | 0.35 | 0.75 | 1.0 | 1.2 | 1.44 |
| Ferric gly phosph | 0.35 | 0.75 | 1.0 | 1.2 | 1.44 | 0.35 | 0.75 | 1.0 | 1.2 | 1.44 |
| Ferrous citrate | 0.35 | 0.75 | 1.0 | 1.2 | 1.44 | 0.35 | 0.75 | 1.0 | 1.2 | 1.44 |
| Ferrous tartrate | 0.35 | 0.75 | 1.0 | 1.2 | 1.44 | 0.35 | 0.75 | 1.0 | 1.2 | 1.44 |
| Ferric orthophosph | 0.35 | 0.75 | 1.0 | 1.2 | 1.44 | 0.35 | 0.75 | 1.0 | 1.2 | 1.44 |
| Iron-containing | Formula III | | | | | Formula IV | | | | |
| material | Ex. 11 | Ex. 12 | Ex. 13 | Ex. 14 | Ex. 15 | Ex. 16 | Ex. 17 | Ex. 18 | Ex. 19 | Ex. 20 |
| Ferrous fumarate | 0.35 | 0.75 | 1.0 | 1.2 | 1.44 | 0.35 | 0.75 | 1.0 | 1.2 | 1.44 |
| Ferrous succinate | 0.35 | 0.75 | 1.0 | 1.2 | 1.44 | 0.35 | 0.75 | 1.0 | 1.2 | 1.44 |
| Ferric saccharate | 0.35 | 0.75 | 1.0 | 1.2 | 1.44 | 0.35 | 0.75 | 1.0 | 1.2 | 1.44 |
| Ferric gly phosph | 0.35 | 0.75 | 1.0 | 1.2 | 1.44 | 0.35 | 0.75 | 1.0 | 1.2 | 1.44 |
| Ferrous citrate | 0.35 | 0.75 | 1.0 | 1.2 | 1.44 | 0.35 | 0.75 | 1.0 | 1.2 | 1.44 |
| Ferrous tartrate | 0.35 | 0.75 | 1.0 | 1.2 | 1.44 | 0.35 | 0.75 | 1.0 | 1.2 | 1.44 |
| Ferric orthophosph | 0.35 | 0.75 | 1.0 | 1.2 | 1.44 | 0.35 | 0.75 | 1.0 | 1.2 | 1.44 |

¹amounts listed as mg elemental iron per 4 packets powdered human milk fortifier (0.9 g powder per packet)

As shown above in Table 4.1, each of the Table 4.0 Formulas I-IV is then prepared as one of many different working examples, each working example having a different iron-containing material and concentration as set forth in the above table. Each working example has a soluble iron content, including soluble unbound iron, of less than 30 mg per 100 g of human milk fortifier solids and an insoluble iron and soluble bound iron component that represents at least about 35% by weight of the total iron. The soluble unbound iron represents less than about 35% by weight of the total iron. The examples based upon Formula IV (added iron availability agent) have a soluble iron or soluble unbound iron reduction of at least about 10%. Each working example when added to human milk does not significantly reduce or otherwise eliminate the inherent, in-vitro antimicrobial activity of the human milk against Escherichia coli, staphylococcus, group B streptococcus, and/or Enterobacter sakazakii. All exemplified formulas contain between 15 mg and 110 mg of iron per 100 g of fortifier solids, and contain zero percent ferrous sulfate and ferric sulfate.

Each working example is added to human milk in the above-described amounts, or as otherwise directed by the physician to best meet the nutritional needs of the infant. The fortified human milk is then administered to both term and preterm infants as their sole source nutrition.

Each of the exemplified human milk fortifier compositions of the present invention is prepared by combining the appropriate ingredients to form a carbohydrate-mineral slurry, an oil blend, and an aqueous protein slurry, and then mixing together all of the formed slurries to form a final blend, which is then processed with an HTST treatment. After standardization, the final blend is spray dried to form a human milk fortifier powder embodiment of the present invention.

The above-referenced working examples based upon Formulas I-TV can be prepared by a number of different techniques well known in the infant formulation art, including the following techniques as applied to a representative bill of materials for preparing a Human Milk Fortifier powder in accordance with the compositions of the present invention (see Table 5).

TABLE 5
Human Milk Fortifier Powder Formulas- Sample Bill of Materials

| Ingredient | Amount | |
|---|---|---|
| Ingredient water | 16,205 | L |
| Corn syrup solids | 1603 | kg |
| Magnesium chloride | 96.2 | kg |
| Potassium citrate | 223.8 | kg |
| Sodium citrate | 6.6 | kg |
| Sodium chloride | 15.4 | kg |
| MCT oil | 801 | kg |
| Lecithin | 16.6 | kg |
| Vitamin A | 2.36 | kg |
| Vitamin D | 359.3 | g |
| Vitamin K | 27.5 | g |
| Natural Vitamin E | 7.6 | kg |
| Calcium carbonate | 33.1 | kg |
| Tricalcium | 646 | kg |
| phosphate | | |
| Whey protein | 1506 | kg |
| concentrate | | |
| Non fat dry milk | 3307 | kg |
| Potassium citrate | 257.2 | g |
| Ferrous fumarate ² | 3.7 | kg |
| Zinc sulfate | 11.1 | kg |
| Copper sulfate | 1.84 | kg |
| Manganese sulfate | 0.320 | kg |
| Sodium selenate | 0.001 | kg |
| Niacinamide | 0.98 | kg |
| Riboflavin | 1.14 | kg |
| Calcium | 4.08 | kg |
| pantothenate | | |
| Pyridoxine | 0.655 | kg |
| hydrochloride | | |
| m-inositol | 9.55 | kg |
| Biotin | 0.0727 | kg |
| Folic acid | 0.0775 | kg |
| Cyanocobalamin | 0.0016 | kg |
| Ascorbic acid | 153.5 | kg |

² The formulation is prepared several times with different iron-containing compounds and concentrations as listed in Table 4.1.

To prepare a human milk fortifier from the Bill of Materials listed in Table 5, and in accordance with the compositions of the present invention, carbohydrate-mineral slurry is prepared by heating 2,763 liters of ingredient water to 54-62° C. With agitation, the specified amounts of corn syrup solids (Maltrin M200 distributed by Grain Processing Corporation, Muscatine, Iowa), magnesium chloride, sodium chloride, sodium citrate, potassium citrate, ultra micronized tricalcium phosphate and calcium carbonate are added to the heated water. The slurry is held under agitation at 54-62° C. for not longer than six hours until it is blended with the other slurries described hereinafter.

An oil blend is then prepared by heating the specified amount of MCT oil (distributed by Stepan, Maywood, N.J.) from 32° C. to 37° C. with agitation. An emulsifier (standard fluid lecithin distributed by Central Soya, Ft. Wayne, Ind.) is then added under agitation and allowed to dissolve. Vitamin A, D, and K, and Natural Vitamin E (distributed by Vitamins, Inc., Chicago, Ill.) are then added to the slurry with agitation. The completed oil slurry is held under moderate agitation at a temperature of from 26° C. to 48° C. for a period of no longer than about six hours until it is blended with the other slurries.

An aqueous protein slurry is then prepared by heating 9,053 liters of ingredient water at 48° C. to 60° C. With agitation, the specified amount of whey protein concentrate (AMP 800 distributed by AMPC, Inc. Ames, Iowa) and nonfat dry milk is added to the heated water. The completed aqueous protein slurry is not held but blended directly with the other slurries.

The aqueous protein slurry, the oil blend, and the carbohydrate-mineral slurries are blended together with agitation and the resultant blend is maintained at a temperature of from 51° C. to 60° C. After waiting for at least five minutes with agitation the final blend pH is adjusted with 1N KOH to a pH from 6.45 to 6.80. The total solids of the final blend is 30%. The final blend is held for no longer than two hours after the pH check.

After waiting for a period of not less than five minutes, but not greater than two hours, the blend is subjected to de-aeration, high-temperature-short-time heat treatment, and homogenization, as follows: A) de-aerate the blend at 10-15 inches Hg; B) emulsify the blend at 900-1100 psig in a single stage homogenizer; C) pass the blend through a plate/coil heater and heat the mix to 71° C. to 82° C.; D) homogenize the blend at 3900 to 4100/400 to 600 psig in a double stage homogenizer; E) pass the blend through a 16 second hold tube at a temperature from 73° C. to 85° C.) cool the blend to a temperature from 1° C. to 7° C.; and G) store the blend at 1° C. to 7° C.

After the above steps have been completed, appropriate analytical testing for quality control is conducted. Based on the analytical results of the quality control tests, batch corrections are made if need be. Final blend total solids range from 29% to 31%.

A water-soluble vitamin solution, ascorbic acid solution and trace mineral solution are prepared separately and added to the processed blend. The ascorbic acid solution is prepared by adding the required amount of ascorbic acid to 2,453 liters of 10° C. to 37° C. water with agitation. The mineral solution is prepared by heating 321 liters of ingredient water to 37° C. to 65° C. Under agitation, add the required amount of potassium citrate and ferrous sulfate. Allow to agitate until the solution is a clear green color. Add the required amounts of zinc sulfate, copper sulfate, manganese sulfate and sodium selenate to the green mineral solution. Agitate five minutes minimum. The water-soluble vitamin solution is prepared by heating 530 liters of ingredient water to 37° C. to 65° C. The required quantities of niacinamide, riboflavin, calcium pantothenate, pyridoxine hydrochloride, thiamine hydrochloride, m-inositol, biotin, folic acid and cyancobalamin are added to the heated water. The resulting ascorbic acid solution, mineral solution, and water-soluble vitamin solution, are then added to the blended slurry under agitation.

The final mix is preheated through a plate heater to 71° C. to 82° C. before going to a surge tank. The mix leaves the surge tank and passes through the steam injector where it is heated to 88° C. to 93° C. The mix enters the vapor-flash chamber where it is cooled to 71° C. to 82° C., then pumped through an in-line 200 micro filter prior to the high pressure pump and into the dryer. The dryer settings are as follows: nozzle pressure 3000-5000 psig; liquid flow rate 11 gpm max; ingoing air temperature 160° C. to 207° C.; and outgoing air temperature 82° C. to 108° C.

To control bulk density, dispersibility, particle size, moisture and physical stability, the specific spray nozzle, nozzle pressure, drying temperatures and fine reinjection parameters may vary depending upon the drying conditions of the day. The powder passes from the dryer into the powder cooler where the powder is cooled to below 43° C. The cooled powder is stored in appropriate containers until being filed in individual packets (˜0.79 g per unit dose packet).

Each packet is mixed with approximately 25 ml of human milk and used to provide a single feeding for an infant, especially a preterm infant, to thus provide the infant with optimal nutrition from a feeding comprising human milk and human milk fortifier. Each packet can also be mixed with an appropriate amount of infant formula to provide a fortified infant formula, to provide optimal nutrition for those infants in need of formula fortification.

### Liquid Human Milk Fortifier

The following example illustrates specific liquid embodiments of the human milk fortifier of the present invention. The example is given solely for the purpose of illustration and is not to be construed as a limitation of the present invention, as many variations thereof are possible without departing from the spirit and scope of the invention.

The liquid human milk fortifier has a total solids content within the range of from 12-40% by weight of the composition. It is prepared by conventional methods for preparing infant liquid nutritional formulas, except that the exemplified formula is subsequently packaged into conventional unit dose packages, wherein each unit dose package contains total fortifier solids ranging from about 0.5 g to about 10 g, and each dose is added to approximately 25 ml of human milk to form a fortified human milk for use in providing infant nutrition, including nutrition for preterm infants. The liquid human milk fortifier provides about 27 kcals per 20 ml, approximately 5 ml of which is combined with 25 ml of human milk. The liquid fortifier is a concentrated formulation having the following nutrient profile:

TABLE 6.0
Nutrient Profile - Liquid Human Milk Fortifier

| | Amount per |
|---|---|
| Nutrient | 20 ml |
| Protein, g | 1.36 |
| Fat, g | 1.02 |
| Carbohydrate, g | 3.24 |
| Minerals | |
| Calcium, mg | 140.6 |
| Phosphorus, mg | 80.6 |
| Magnesium, mg | 8.66 |
| Sodium, mg | 21.8 |
| Potassium, mg | 83.4 |
| Chloride, mg | 53 |
| Zinc, mg | 1.26 |
| Copper, mg | 209.6 |
| Iron, mg * | 0.35-1.44 |
| Vitamins | |
| A, IU | 791 |
| D, IU | 140.8 |
| E, IU | 3.94 |
| K, μg | 9.75 |
| C, mg | 31 |
| B₁, mg | 275.4 |
| B_{2, mg} | 495.6 |
| B₁₂, μg | 0.15 |
| Niacin, mg | 4.17 |
| Pantothenic acid, mg | 1.92 |
| Folic acid, μg | 27.4 |

* Iron-containing materials described in Table 6.1

The nutrient listing of Table 6.0 is formulated with a variety of iron-containing materials described in Table 6.1 to provide the liquid fortifier with 0.35-1.44 mg elemental iron per 20 ml of fortifier.

TABLE 6.1
Human Milk Fortifier Powder Formulas -
Iron-Containing Material

| Iron-containing Material | Elemental Iron, mg per 20 ml |
|---|---|
| Ferrous fumarate | 0.35-1.44 |
| Ferrous succinate | 0.35-1.44 |
| Ferric saccharate | 0.35-1.44 |
| Ferric gly phosph | 0.35-1.44 |
| Ferrous citrate | 0.35-1.44 |
| Ferrous tartrate | 0.35-1.44 |
| Ferric orthophosph | 0.35-1.44 |

We claim:

1. A human milk fortifier composition comprising:
(a) protein, lipid, carbohydrate, or combinations thereof; and
(b) an iron-containing material containing
(i) soluble unbound iron, insoluble iron, or combinations thereof, and
(ii) from about 3 mg to about 30 mg soluble iron per 100 g of human milk fortifier solids in the composition,
wherein the composition is a human milk fortifier.

2. The composition of claim 1 wherein the composition has a total iron content of from about 10 mg to about 110 mg per 100 g of human milk fortifier solids, and wherein from about 10% to 100% by weight of the total iron in the composition is insoluble iron, soluble bound iron, or combinations thereof.

3. The composition of claim 2 wherein from about 50% to about 95% by weight of the total iron is insoluble iron, soluble bound iron, or combinations thereof.

4. The composition of claim 1 wherein the composition has a total iron content of from about 20 mg to about 50 mg per 100 g of human milk fortifier solids.

5. The composition of claim 1 wherein the composition comprises from about 5 mg to about 25 mg soluble iron per 100 g of human milk fortifier solids.

6. The composition of claim 1 wherein the composition is substantially free of ferrous sulfate, ferric sulfate, and combinations thereof.

7. The composition of claim 1 wherein the composition comprises one or more iron-containing materials selected from the group consisting of ferrous fumarate, ferrous succinate, ferric saccharate, ferric glycerophosphate, ferrous citrate, ferrous tartrate, ferric pyrophosphate, and ferric orthophosphate.

8. The composition of claim 1 wherein the composition the iron-containing material comprises ferrous fumarate.

9. The composition of claim 1 wherein the composition comprises, per 100 g of fortifier solids, from about 15 g to about 75 g of carbohydrate, from about 1 to about 30 g of lipid, and from about 24 g to about 55 g of protein.

10. The composition of claim 1 wherein the composition comprises, per 100 g of fortifier solids, from about 38 g to about 70 g of carbohydrate, from about 5 g to about 20 g of lipid, and from about 25 g to 42 g of protein.

11. The composition of claim 1 wherein the composition is in powder form.

12. The composition of claim 1 wherein the composition is in liquid form.

13. The composition of claim 12 wherein the liquid composition comprises at least about 20% by weight of fortifier solids and less than about 80% by weight of water.

14. The composition of claim 12 wherein the liquid composition comprises from about 20% to about 40% fortifier solids and less than about 80% by weight of water.

15. The composition of claim 12 wherein the liquid composition is a liquid concentrate for use in combination with human milk in a volume/volume ratio of the liquid concentrate to the human milk of from about 1:2 to about 1:10

16. The composition of claim 1 wherein the composition further comprises an iron availability agent.

17. The composition of claim 16 wherein the iron availability agent reduces the concentration of soluble unbound iron in the composition by at least about 10% by weight.

18. The composition of claim 16 wherein the iron availability agent reduces the concentration of soluble unbound iron by at least about 50% by weight.

19. The composition of claim 16 wherein the iron availability agent comprises up to about 10 g of phosphate ions per 100 g of fortifier solids.

20. The composition of claim 19 wherein the phosphate ion is provided by NaH₂PO₄, Na₂HPO₄, KH₂PO₄, K₂HPO₄, H₃PO₄, Ca glycerophosphate, Ca(H₂PO₄)₂, CaHPO₄, Ca₃(PO₄)₂, Ca₂P₂O₇, Mg(H₂PO₄)₂, MgHPO₄, Mg₃(PO₄)₂, Mg₂(P₂O₇), or combinations thereof.

21. The composition of claim 1 further comprising at least about 0.1 g of lactoferrin per mg of iron in the composition.

22. A human milk fortifier composition comprising:
(a) protein, lipid, carbohydrate, or combinations thereof; and
(b) an iron-containing material comprising one or more of ferrous fumarate, ferrous succinate, ferric saccharate, ferric glycerophosphate, ferrous citrate, ferrous tartrate, ferric pyrophosphate, or ferric orthophosphate;
wherein the composition is a human milk fortifier.

23. The composition of claim 22 wherein the composition has a total iron content of from about 10 mg to about 110 mg per 100 g of human milk fortifier solids, and wherein from about 10% to 100% by weight of the total iron in the composition is insoluble iron, soluble bound iron, or combinations thereof.

24. The composition of claim 23 wherein from about 50% to about 95% by weight of the total iron is insoluble iron, soluble bound iron, or combinations thereof.

25. The composition of claim 23 wherein the composition has a total iron content of from about 20 mg to about 50 mg per 100 g of human milk fortifier solids.

26. The composition of claim 22 wherein the iron-containing material comprises ferrous fumarate.

27. The composition of claim 22 wherein the composition comprises, per 100 g of fortifier solids, from about 15 g to about 75 g of carbohydrate, from about 1 to about 30 g of lipid, and from about 24 g to about 55 g of protein.

28. The composition of claim 22 wherein the composition comprises, per 100 g of fortifier solids, from about 38 g to about 70 g of carbohydrate, from about 5 g to about 20 g of lipid, and from about 25 g to 42 g of protein.

29. The composition of claim 22 wherein the composition is in powder form.

30. The composition of claim 22 wherein the composition is in liquid form.

31. The composition of claim 30 wherein the liquid composition comprises at least about 20% by weight of fortifier solids and less than about 80% by weight of water.

32. The composition of claim 30 wherein the liquid composition comprises from about 20% to about 40% fortifier solids and less than about 80% by weight of water.

33. The composition of claim 30 wherein the liquid composition is a liquid concentrate for use in combination with human milk in a volume/volume ratio of the liquid concentrate to the human milk of from about 1:2 to about 1:10

34. A human milk fortifier composition comprising:
(a) protein, lipid, carbohydrate, or combinations thereof;
(b) from about 15 mg to about 110 mg of iron per 100 g of human milk fortifier solids; and
(c) an iron availability agent;
wherein the composition is a human milk fortifier.

35. The composition of claim 34 wherein the composition has a total iron content of from about 20 mg to about 50 mg per 100 g of human milk fortifier solids.

36. The composition of claim 34 wherein the composition comprises soluble unbound iron, and wherein the iron availability agent reduces the soluble unbound iron concentration by at least about 10% by weight.

37. The composition of claim 36 wherein the iron availability agent reduces the concentration of soluble unbound iron by at least about 50% by weight.

38. The composition of claim 34 wherein the iron availability agent comprises up to about 10 g of phosphate ions per 100 g of fortifier solids.

39. The composition of claim 34 wherein the phosphate ion is provided by NaH₂PO₄, Na₂HPO₄, KH₂PO₄, K₂HPO₄, H₃PO₄, Ca glycerophosphate, Ca(H₂PO₄)₂, CaHPO₄, Ca₃(PO₄)₂, Ca₂P₂O₇, Mg(H₂PO₄)₂, MgHPO₄, Mg₃(PO₄)₂, Mg₂(P₂O₇), or combinations thereof.

40. The composition of claim 34 wherein from about 10% to 100% by weight of the total iron in the composition is insoluble iron, soluble bound iron, or combinations thereof.

41. The composition of claim 34 wherein from about 50% to about 95% by weight of the total iron is insoluble iron, soluble bound iron, or combinations thereof.

42. The composition of claim 34 wherein the composition is substantially free of ferrous sulfate, ferric sulfate, and combinations thereof.

43. The composition of claim 34 wherein the composition comprises, per 100 g of fortifier solids, from about 15 g to about 75 g of carbohydrate, from about 1 to about 30 g of lipid, and from about 24 g to about 55 g of protein.

44. The composition of claim 34 wherein the composition comprises, per 100 g of fortifier solids, from about 38 g to about 70 g of carbohydrate, from about 5 g to about 20 g of lipid, and from about 25 g to 42 g of protein.

45. The composition of claim 34 wherein the composition is in powder form.

46. The composition of claim 34 wherein the composition is in liquid form.

47. The composition of claim 46 wherein the liquid composition comprises at least about 20% by weight of fortifier solids and less than about 80% by weight of water.

48. The composition of claim 46 wherein the liquid composition comprises from about 20% to about 40% fortifier solids and less than about 80% by weight of water.

49. The composition of claim 46 wherein the liquid composition is a liquid concentrate for use in combination with human milk in a volume/volume ratio of the liquid concentrate to the human milk of from about 1:2 to about 1:10

50. The composition of claim 34 further comprising at least about 0.1 g of lactoferrin per mg of iron in the composition.

51. A human milk fortifier composition comprising:
(a) protein, lipid, carbohydrate, or combinations thereof;
(b) an iron-containing material; and
(c) at least about 0.1 g lactoferrin per mg of iron in the composition;
wherein the composition is a human milk fortifier.

52. The composition of claim 51 wherein the composition comprises from about 0.7 g to about 3 g lactoferrin per mg of iron in the composition.

53. The composition of claim 51 wherein the composition has a total iron content of from about 10 mg to about 110 mg per 100 g of human milk fortifier solids, and wherein from about 10% to 100% by weight of the total iron in the composition is insoluble iron, soluble bound iron, or combinations thereof.

54. The composition of claim 51 wherein from about 50% to about 95% by weight of the total iron is insoluble iron, soluble bound iron, or combinations thereof.

55. The composition of claim 51 wherein the composition has a total iron content of from about 20 mg to about 50 mg per 100 g of human milk fortifier solids.

56. The composition of claim 51 wherein the composition comprises, per 100 g of fortifier solids, from about 15 g to about 75 g of carbohydrate, from about 1 to about 30 g of lipid, and from about 24 g to about 55 g of protein.

57. The composition of claim 51 wherein the composition comprises, per 100 g of fortifier solids, from about 38 g to about 70 g of carbohydrate, from about 5 g to about 20 g of lipid, and from about 25 g to 42 g of protein.

58. The composition of claim 51 wherein the composition is in powder form.

59. The composition of claim 51 wherein the composition is in liquid form.

60. The composition of claim 59 wherein the liquid composition comprises at least about 20% by weight of fortifier solids and less than about 80% by weight of water.

61. The composition of claim 59 wherein the liquid composition comprises from about 20% to about 40% fortifier solids and less than about 80% by weight of water.

62. The composition of claim 59 wherein the liquid composition is a liquid concentrate for use in combination with human milk in a volume/volume ratio of the liquid concentrate to the human milk of from about 1:2 to about 1:10

63. A human milk fortifier composition comprising:
(a) protein, lipid, carbohydrate, or combinations thereof; and
(b) from about 15 mg to about 110 mg of iron per 100 g of fortifier solids, wherein from about 30% to 100% by weight of the iron in the composition is insoluble iron, soluble bound iron, or combinations thereof;
wherein the composition is a human milk fortifier.

64. The composition of claim 63 wherein from about 50% to about 95% by weight of the iron is insoluble iron, soluble bound iron, or combinations thereof.

65. The composition of claim 63 wherein the composition comprises from about 20 mg to about 50 mg of iron per 100 g of human milk fortifier solids.

66. The composition of claim 63 wherein the composition is substantially free of ferrous sulfate, ferric sulfate, and combinations thereof.

67. The composition of claim 63 wherein the composition comprises one or more of ferrous fumarate, ferrous succinate, ferric saccharate, ferric glycerophosphate, ferrous citrate, ferrous tartrate, ferric pyrophosphate, or ferric orthophosphate.

68. The composition of claim 63 wherein the composition comprises ferrous fumarate.

69. The composition of claim 63 wherein the composition comprises, per 100 g of fortifier solids, from about 15 g to about 75 g of carbohydrate, from about 1 to about 30 g of lipid, and from about 24 g to about 55 g of protein.

70. The composition of claim 63 wherein the composition comprises, per 100 g of fortifier solids, from about 38 g to about 70 g of carbohydrate, from about 5 g to about 20 g of lipid, and from about 25 g to 42 g of protein.

71. The composition of claim 63 wherein the composition is in powder form.

72. The composition of claim 63 wherein the composition is in liquid form.

73. The composition of claim 72 wherein the liquid composition comprises at least about 20% by weight of fortifier solids and less than about 80% by weight of water.

74. The composition of claim 72 wherein the liquid composition comprises from about 20% to about 40% fortifier solids and less than about 80% by weight of water.

75. The composition of claim 72 wherein the liquid composition is a liquid concentrate for use in combination with human milk in a volume/volume ratio of the liquid concentrate to the human milk of from about 1:2 to about 1:10

76. The composition of claim 63 wherein the composition further comprises an iron availability agent.

77. The composition of claim 76 wherein the iron availability agent reduces the concentration of soluble unbound iron in the composition by at least about 10% by weight.

78. The composition of claim 76 wherein the iron availability agent reduces the concentration of soluble unbound iron by at least about 50% by weight.

79. The composition of claim 76 wherein the iron availability agent comprises up to about 10 gm of phosphate ions per 100 g of fortifier solids.

80. The composition of claim 79 wherein the phosphate ion is provided by NaH₂PO₄, Na₂HPO₄, KH₂PO₄, K₂HPO₄, H₃PO₄, Ca glycerophosphate, Ca(H₂PO₄)₂, CaHPO₄, Ca₃(PO₄)₂, Ca₂P₂O₇, Mg(H₂PO₄)₂, MgHPO₄, Mg₃(PO₄)₂, Mg₂(P₂O₇), or combinations thereof.

81. A human milk fortifier composition comprising:
(a) protein, lipid, carbohydrate, or combinations thereof; and
(b) an iron-containing material wherein from about 30% to about 70% by weight of the iron in the composition is insoluble iron, soluble bound iron, or combinations thereof,
wherein the composition is a human milk fortifier.

82. The composition of claim 81 wherein the composition has a total iron content of from about 15 mg to about 100 mg per 100 g of human milk fortifier solids.

83. The composition of claim 81 wherein the composition has a total iron content of from about 20 mg to about 50 mg per 100 g of human milk fortifier solids.

84. The composition of claim 81 wherein from about 40% to about 60% by weight of the iron in the composition is insoluble iron, soluble bound iron, or combinations thereof.

85. The composition of claim 81 wherein the composition is substantially free of ferrous sulfate, ferric sulfate, and combinations thereof.

86. The composition of claim 81 wherein the composition comprises, per 100 g of fortifier solids, from about 15 g to about 75 g of carbohydrate, from about 1 to about 30 g of lipid, and from about 24 g to about 55 g of protein.

87. The composition of claim 81 wherein the composition comprises, per 100 g of fortifier solids, from about 38 g to about 70 g of carbohydrate, from about 5 g to about 20 g of lipid, and from about 25 g to 42 g of protein.

88. The composition of claim 81 wherein the composition is in powder form.

89. The composition of claim 81 wherein the composition is in liquid form.

90. The composition of claim 89 wherein the liquid composition comprises at least about 20% by weight of fortifier solids and less than about 80% by weight of water.

91. The composition of claim 89 wherein the liquid composition comprises from about 20% to about 40% fortifier solids and less than about 80% by weight of water.

92. The composition of claim 89 wherein the liquid composition is a liquid concentrate for use in combination with human milk in a volume/volume ratio of the liquid concentrate to the human milk of from about 1:2 to about 1:10

93. The composition of claim 81 wherein the composition further comprises an iron availability agent.

94. The composition of claim 93 wherein the iron availability agent reduces the concentration of soluble unbound iron by at least about 50% by weight.

95. The composition of claim 93 wherein the iron availability agent comprises up to about 10 gm of phosphate ions per 100 g of fortifier solids.

96. The composition of claim 95 wherein the phosphate ion is provided by NaH₂PO₄, Na₂HPO₄, KH₂PO₄, K₂HPO₄, H₃PO₄, Ca glycerophosphate, Ca(H₂PO₄)₂, CaHPO₄, Ca₃(PO₄)₂, Ca₂P₂O₇, Mg(H₂PO₄)₂, MgHPO₄, Mg₃(PO₄)₂, Mg₂(P₂O₇), or combinations thereof.

97. A human milk fortifier composition comprising:
(a) protein, lipid, carbohydrate, or combinations thereof; and
(b) an iron-containing material wherein from about 10% to 100% by weight of the iron is insoluble iron, soluble bound iron, or combinations thereof, and wherein the composition is substantially free of ferrous sulfate, ferric sulfate, or combinations thereof;
and wherein the composition is a human milk fortifier.

98. The composition of claim 97 wherein the composition contains less than about 0.1 mg of ferrous sulfate, ferric sulfate, and combinations thereof, per 100 g of fortifier solids.

99. The composition of claim 97 wherein from about 50% to 95% by weight of the iron in the composition is insoluble iron, soluble bound iron, or combinations thereof.

100. A method of providing nutrition to infants, said method comprising adding the human milk fortifier of claim 1 to human milk to form a fortified human milk, and then administering the fortified human milk to the infant.

101. A method of providing nutrition to infants, said method comprising adding the human milk fortifier of claim 22 to human milk to form a fortified human milk, and then administering the fortified human milk to the infant.

102. A method of providing nutrition to infants, said method comprising adding the human milk fortifier of claim 34 to human milk to form a fortified human milk, and then administering the fortified human milk to the infant.

103. A method of providing nutrition to infants, said method comprising adding the human milk fortifier of claim 51 to human milk to form a fortified human milk, and then administering the fortified human milk to the infant.

104. A method of providing nutrition to infants, said method comprising adding the human milk fortifier of claim 63 to human milk to form a fortified human milk, and then administering the fortified human milk to the infant.

105. A method of providing nutrition to infants, said method comprising adding the human milk fortifier of claim 81 to human milk to form a fortified human milk, and then administering the fortified human milk to the infant.

106. A method of providing nutrition to infants, said method comprising adding the human milk fortifier of claim 97 to human milk to form a fortified human milk, and then administering the fortified human milk to the infant.

107. A method of providing nutrition to preterm infants, said method comprising adding the human milk fortifier of claim 1 to human milk to form a fortified human milk, and then administering the fortified human milk to preterm infants.

108. A method of providing nutrition to preterm infants, said method comprising adding the human milk fortifier of claim 22 to human milk to form a fortified human milk, and then administering the fortified human milk to preterm infants.

109. A method of providing nutrition to preterm infants, said method comprising adding the human milk fortifier of claim 34 to human milk to form a fortified human milk, and then administering the fortified human milk to preterm infants.

110. A method of providing nutrition to preterm infants, said method comprising adding the human milk fortifier of claim 51 to human milk to form a fortified human milk, and then administering the fortified human milk to preterm infants.

111. A method of providing nutrition to preterm infants, said method comprising adding the human milk fortifier of claim 63 to human milk to form a fortified human milk, and then administering the fortified human milk to preterm infants.

112. A method of providing nutrition to preterm infants, said method comprising adding the human milk fortifier of claim 81 to human milk to form a fortified human milk, and then administering the fortified human milk to preterm infants.

113. A method of providing nutrition to preterm infants, said method comprising adding the human milk fortifier of claim 97 to human milk to form a fortified human milk, and then administering the fortified human milk to preterm infants.
